(19) United States
(12) Patent Application Publication
(10) Pub. No.: US 2018/0030387 A1
(43) Pub. Date: Feb. 1, 2018

(54) CLEANING COMPOSITION COMPRISING A BLEACH CATALYST AND CARBOXYMETHYLCELLULOSE

(71) Applicant: Dalli-Werke GmbH & Co. KG, Stolberg (DE)

(72) Inventors: Janco VAN OMMEN, Zwolle (NL); Robbert DE BOER, Oene (NL); Cathy VAN BOVEN, Dronten (NL); Khalid MAHMUD, Elburg (NL); Paula SANTBULTE, Zwolle (NL); René MOL, Hollandscheveld (NL)

(73) Assignee: Dalli-Werke GmbH & Co. KG, Stolberg (DE)

(21) Appl. No.: 15/548,748

(22) PCT Filed: Feb. 3, 2016
(86) PCT No.: PCT/EP2016/052231

§ 371 Date: Aug. 3, 2017

(30) Foreign Application Priority Data
Feb. 5, 2015 (EP) 15153929.3

(51) Int. Cl. C11D 3/39; C11D 3/22

(52) U.S. Cl. CPC C11D 3/3935; C11D 3/225; C11D 3/392

(57) ABSTRACT

Disclosed is a cleaning composition containing a metal-containing bleach catalyst, a carboxymethylcellulose (CMC) and further commonly used cleaning composition ingredients such as a builder, a surfactant, polymers/cobuilders, and an enzyme. Preferably, the cleaning composition does not contain a bleach activator such as tetraacetylethylenediamine (TAED). Preferably, the metal-containing bleach catalyst contained in the cleaning composition is a cobalt (Co) containing bleach catalyst or a manganese (Mn) containing bleach catalyst. In the cleaning composition, the carboxymethylcellulose is preferably present in an amount of at least 0.02% (w/w), preferably at least 0.05% (w/w) relative to total amount of the cleaning composition.

The present application refers to cleaning compositions comprising a metal containing bleach catalyst, carboxymethylcellulose (CMC) and further commonly used cleaning composition ingredients, however, preferably is free of TAED.

TAED is a compound which was used as a bleach activator in cleaning compositions for long times. Since TAED is not very stable in liquid forms of cleaning compositions, it was usually provided and added to the composition in granulate form, wherein said granulate was prepared by cogranulating the TAED with a polymeric binder, like e.g. cellulose, CMC or similar suitable polymers. During the last years bleaching systems of cleaning compositions were established using bleach catalysts instead or in addition to said bleach activator TAED, thus said granules were omitted from the composition.

Carboxymethylcellulose (CMC) is not only a suitable binder for cogranulation processes, but further serves in cleaning compositions as a anti-redeposition agent. In modern cleaning compositions not including TAED granules no more, the CMC source of the granules using CMC as a binder is not maintained.

It was an object of the present invention to provide a cleaning composition which is effective in cleaning and bleaching and further prevents solid soil residues in the waste water or filter systems of automatic washing machines.

This object is met by a cleaning composition comprising at least a metal containing bleach catalyst and CMC. In a preferred embodiment the cleaning composition comprises at least a metal containing bleach catalyst and CMC, however, no bleach activator, in particular no TAED

The cleaning composition of the present invention is preferably a dishwashing composition or a laundry cleaning composition, more preferably an automatic dishwashing composition (ADD).

The composition of the present invention comprises at least one metal containing bleach catalyst that is selected from bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts. Such catalysts are broadly discribed in the state of the art, e.g. as mentioned above, and well known by skilled artisans.

In U.S. Pat. No. 4,430,243 one type of metal-containing bleach catalyst is disclosed which is a catalyst system comprising a transition metal cation of defined bleach catalytic activity, such as copper, iron, titanium, ruthenium tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof.

Other types of bleach catalysts include the manganese-based complexes disclosed in U.S. Pat. No. 5,246,621 and U.S. Pat. No. 5,244,594. Preferred examples of theses catalysts include Mn^{IV}₂(μ-O)₃(1,4,7-trimethyl-1,4,7-triazacyclononane)₂-(PF₆)₂(“MnTACN”), Mn^{III}₂(μO)₁(μ-OAc)₂(1,4,7-trimethyl-1,4,7-triazacyclononane)₂-(ClO₄)₂, Mn^{IV}₄(μO)₆(1,4,7-triazacyclononane)₄-(ClO₄)₂, Mn^{III}Mn^{IV}₄(μ-O)₁ (μ-OAc)₂(1,4,7-trimethyl-1,4,7-triazacyclononane)₂-(ClO₄)₃, and mixtures thereof. See also European patent application 549,272. Other ligands suitable for use herein include 1,5,9-trimethyl-1,5,9-triazacyclododecane, 2-methyl-1,4,7-triazacyclononane, 2-methyl-1,4,7-triazacyclononane, and mixtures thereof and mixtures of pentaamineacetate cobalt (III) nitrate and MnTACN.

The bleach catalysts useful in automatic dishwashing compositions and concentrated powder detergent compositions may also be used in present invention. For examples of suitable bleach catalysts see U.S. Pat. No. 4,246,612 and U.S. Pat. No. 5,227,084, or U.S. Pat. No. 5,194,416 which teaches mononuclear manganese (IV) complexes such as Mn(1,4,7-trimethyl-1,4,7-triazacyclononane(OCH₃)₃₋(PF₆).

Still another type of bleach catalyst, as disclosed in U.S. Pat. No. 5,114,606, is a water-soluble complex of manganese (II), (III), and/or (IV) with a ligand which is a non-carboxylate polyhydroxy compound having at least three consecutive C—OH groups. Preferred ligands include sorbitol, iditol, dulsitol, mannitol, xylitol, arabitol, adonitol, meso-erythritol, meso-inositol, lactose, and mixtures thereof.

U.S. Pat. No. 5,114,611 teaches a bleach catalyst comprising a complex of transition metals, including Mn, Co, Fe, or Cu, with an non-(macro)-cyclic ligand. Said ligands are of the formula: R¹R²N═C—B(R³)—C═NR⁴, wherein R¹, R², R³, and R⁴ can each be selected from H, substituted alkyl and aryl groups such that each R¹—N═C—R² and R³—C═N—R⁴ form a five or six-membered ring. Said ring can further be substituted. B is a bridging group selected from O, S, CR⁵R⁶, NR⁷ and C═O, wherein R⁵, R⁶, and R⁷ can each be H, alkyl, or aryl groups, including substituted or unsubstituted groups. Preferred ligands include pyridine, pyridazine, pyrimidine, pyrazine, imidazole, pyrazole, and triazole rings. Optionally, said rings may be substituted with substituents such as alkyl, aryl, alkoxy, halide, and nitro. Particularly preferred is the ligand 2,2′-bispyridylamine. Preferred bleach catalysts include Co, Cu, Mn, Fe,-bispyridylmethane and-bispyridylamine complexes. Highly preferred catalysts include Co(2,2′-bispyridylamine)Cl₂, Di(isothiocyanato)bispyridylamine-cobalt (II), trisdipyridylamine-cobalt(II) perchlorate, Co(2,2-bispyridylamine)₂O₂ClO₄, Bis-(2,2′-bispyridylamine) copper(II) perchlorate, tris(di-2-pyridylamine) iron(II) perchlorate, and mixtures thereof.

Other examples include Mn gluconate, Mn(CF₃SO₃)₂, Co(NH₃)₅Cl, and the binuclear Mn complexed with tetra-N-dentate and bi-N-dentate ligands, including N₄Mn^{III}(μ-O)₂Mn^{IV}N₄)⁺ and [Bipy₂Mn^{III}(μO)₂Mn^{IV}bipy₂]-(ClO₄)₃.

Complexes of manganese in the valence state II, III, IV or V which preferably comprise one or a plurality of macrocyclic ligands with the donor functions N, NR, PR, O and/or S are particularly preferably employed. Ligands having nitrogen donor functions are preferably employed. In this regard, it is particularly preferred to select the at least one bleach catalyst from such having a group 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) 1,2,4,7,-tetramethyl-1,4,7-triazacyclononane and/or 2-methyl-1,4,7-triazacyclononane (Me/TACN) as the macromolecular ligands. Preferred manganese complexes are for example [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}4(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂(MnTACN), [Mn^{IV}₂(μ-O)₃(Me/Me-TACN)₂](PF₆)₂(OAc═OC(O)CH₃) and the complex of Mn^{VI} with 1,2,4,7,-tetramethyl-1,4,7-triazacyclononane.

In a particularly preferred embodiment at least one metal containing bleach catalyst used according to the invention is MnTACN.

The bleach catalyst may amount from at least 0.002 wt.-%, preferably at least 0.004 wt.-%, more preferably from 0.008 to 0.23 wt.-%, more preferably from 0.012 to 0.15 wt.-%, even more preferably from 0.016 to 0.12 wt.-%, most preferably from 0.016 to 0.08 wt.-% of the cleaning composition. These amounts are represented e.g. by a dosis of at least 0.5 mg, preferably at least 1 mg, more preferred 2 to 30 mg, more preferred 3 to 20 mg, even more preferred 4 to 15 mg, most preferred 4 to 10 mg of bleach catalyst added with a 13 to 25 gram dosis of the remaining cleaning composition (as one wash load).

The bleach catalyst can be added in form of granules, e.g. granules comprising MnTACN and a binder. In a preferred embodiment said binder can be CMC. In other embodiments the binder might be any other suitable binder, like organic polymers or carboxylate compounds, water soluble inorganic and organic salts, silicates, organic compounds having a molecular weight of less than 500 g/mol e.g. sugars, citrate, succinate, maleate and organic polymers having a molecular weight of 800-1,000,000 g/mol preferably selected from the group consisting of homo- and co-polymers, including graft co-polymers, more preferred from polyacrylic acid or derivatives thereof, polyethylene glycols or derivatives thereof, polyvinyl alcohol or derivatives thereof, polyvinylpyrrolidone or derivatives thereof, starch or derivatives thereof, cellulose or derivatives thereof, a polyvinyl alcohol-polyethylene glycol graft co-polymer, polyethylene, polysaccharides, polyglucose, guargum, pectin, lignin, cerragen gum, proteins others than enzymes, or mixtures of any of the mentioned. In case that such granules comprising the bleach catalyst and CMC as a binder is used, the amount described below for the addition of CMC can be either provided solely by said granules, or the granules are provided side by side to the addition of further CMC. Further the bleach catalyst can be provided in form of enzyme-comprising granules as described below.

The cleaning composition according to the present invention comprises carboxymethylcellulose (CMC) in an amount of at least 0.02% (w/w), preferably of at least 0.05% of the cleaning composition, preferably in a range of 0.05 to 5%, more preferred in the range of 0.1 to 4%, even more preferred 0.15 to 3%. The CMC has preferably an average degree of substitution (ds) of at least 0.1, preferably between 0.1 to 2.5, preferably between 0.2 and 2.0, more preferably between 0.3 and 1.5 and most preferably between 0.4 and 1.0.

Said CMC may be added to the cleaning composition in form of free flowing powder, in form of granules or as part of granules (e.g. by serving as a binder).

According to the present invention it is particularly preferred that the cleaning composition doesn't comprise a bleach activator, in particular no TAED. With bleach activator any compound is meant providing the possibility to use a comparatively low temperature to achieve the desired bleaching performance when inorganic peroxygen based bleaching agents are applied. Such a bleach activator reacts with the peroxygen to form an organic peracid. Depending from the used bleach activator these peracids can have a hydrophobic or a hydrophilic character.

Examples of bleach activators agents commonly used in cleaning compositions include, but are not limited to, tetraacetylethylenediamine (TAED), sodium nonanoyloxybenzene sulfonate (NOBS), acetyl caprolactone, N-methyl morpholinium acetonitrile and salts thereof, sodium 4-(2-decanoyloxyethoxycarbonyloxy)benzenesulfonate (DECOBS) and salts thereof, lauryloxybenzylsulfonate (LOBS), iso-lauryloxybenzylsulfonate (I-LOBS), N-methylmorpholinum-acetonitril (MMA), Pentaacetylglucose, Nitrilquats, Benzoylcaprolactam (BzCL), 4-nitrobenzoylcaprolactam, 3-clorobenzoylcaprolactam, benzoyloxybenzylsulfonate (BOBS), phenylbenzoate (PhBz), decanoyloxybenzylsulfonate (C10-OBS), benzoylvalerolactam (BZVL), octanoyloxybenzylsulfonate (C8-OBS), 4-[N-(nonanoyl)aminohezanoyloxy]-benzylsulfonate-sodium salt (NACA-OBS), 10-undecenoyloxybenzylsulfonate (UDOBS), decanoyloxybenzoec acid (DOBA), perhydrolyzable ester, perhydrolytic enzyme combined with an by this enzyme hydrolysable substrate, acetyl caprolactone, Acetyl caprolactam (N-acetylhexanelactam) (e.g. Peractive LAC) N-methyl morpholinium acetonitrile and salts thereof (such as Sokalan BMG from BASF).

The cleaning composition can be provided in form a powder, granulates, a mono-layer tablet, a multi-layer or multiphase (e.g. tab in tab) tablet, a bar, a pouch, a pouch with different compartments, a liquid or any other suitable form or combinations thereof. Particularly preferred, the cleaning composition comprising said granulate particles is provided in form of a pouch, a pouch with different compartments or a tablet, preferably a multiphase tablet.

Further Ingredients

The cleaning composition(s) of the present invention may further comprise any of the ingredients known in the art as common ingredients in cleaning compositions, particularly in automatic dishwashing compositions. Such at least one further ingredient is selected from the group consisting of e.g. builders, surfactants, preferably non-ionic and/or anionic surfactants, polymers/cobuilders, enzymes, complexing agents, bleaching agents, dispersing agents, optical brighteners, stabilizers, colorants, odorants, anti-redeposition agents, anti-corrosion agents, tableting agents, disintegrants, silver protecting agents, dyes, and perfume, without any restriction.

In preferred embodiments the cleaning composition comprises as further ingredients at least one type of a builder, at least one type of a surfactant, preferably non-ionic and/or anionic surfactants, at least one bleaching agent, at least one polymers/cobuilders and at least one enzyme.

Furthermore, all of the optional ingredients known in the state of the art to be effective or usable in cleaning compositions, particular in automatic dishwashing compositions might be included.

Said further ingredients are not limiting the present invention.

The following further ingredients represent examples of ingredients which can be included in a cleaning composition of the present invention, however should not be considered as limited to the mentioned.

Builder(s), Co-Builder(s)

The composition of the present invention preferably comprise one or more builder(s) as at least one further ingredient.

The main functions of the builders are to soften the washing water, to provide alkalinity and a buffering capacity to the washing liquid and to have an anti-redeposition or dispersing function in the cleaning composition. The physical properties of the cleaning composition are also depending on the builders that are used.

For controlling the pH of the composition, as well as its mineral hardness, inorganic as well as organic builders may be incorporated into the composition. In addition, these builders may assist in the removal of particulate soil. If present in the composition according to the present invention, the builder or the mixture of builders preferably will be present in an amount of from 0.1 to 90 wt.-%, preferably in an amount of from 5-80 wt.-%, more preferably in an amount of 8-70 wt.-%, and even more preferably in an amount of from 10-50 wt.-%, based on the whole composition.

Included among the builders in this context are, in particular, the silicates, aluminosilicates, carbonates, sulfates, organic co-builders, and—in cases where no environmental prejudices against their use exist—also the phosphates. Suitable phosphate builders include alkaline, ammonium or alkanolammonium salts of polyphosphates, including tripolyphosphates, pyrophosphates and polymeric meta-phosphates. In one embodiment, the composition of the present invention comprises less than 5 wt.-% of a polyphosphate builder, based on the whole composition.

Among the plurality of commercially obtainable phosphates, the alkali metal phosphates have the highest importance for the agents according to the present invention, with particular preference for pentasodium triphosphate, Na₅P₃O₁₀ (sodium tripolyphosphate) resp. pentapotassium triphosphate, K₅P₃O₁₀ (potassium tripolyphosphate).

If phosphates are used, the weight proportion of the phosphate in terms of the total weight of the cleaning composition is preferably from 1 to 70 wt.-%, more preferably from 10 to 60 wt.-%, and most preferred from 20 to 50 wt.-%.

In addition to or instead of an inorganic builder the composition of the present invention may as well comprise an organic builder, including polycarboxylate builders in the form of their acid or a salt, including alkali metal salts such as potassium, sodium and lithium salts.

The group of preferred builders includes in particular the citrates as well as the carbonates and the organic co-builders. The term “citrate” hereby includes both citric acid as well as its salts, in particular its alkali metal salts.

Carbonate(s) and/or hydrogen carbonate(s), preferably alkali metal carbonate(s), particularly preferably sodium carbonate, are particularly preferably added in quantities of 5 to 70 wt.-%, preferably 10 to 40 wt.-% and especially 15 to 60 wt.-%, each relative to the weight of the dishwashing agent.

Polycarboxylates/polycarboxylic acids and phosphonates may be particularly mentioned as the organic co-builders. These classes of substances are described below.

Useful organic builders are, for example, the polycarboxylic acids that can be used in the form of the free acid and/or their sodium salts, polycarboxylic acids in this context being understood to be carboxylic acids that carry more than one acid function. These include, for example, adipic acid, succinic acid, glutaric acid, malic acid, tartaric acid, maleic acid, fumaric acid, sugar acids, amino carboxylic acids, nitrilotriacetic acid (NTA) and mixtures thereof. Besides their building effect, the free acids also typically have the property of an acidifying component and hence also serve to establish a relatively low and mild pH of the inventive agents. Succinic acid, glutaric acid, adipic acid, gluconic acid and any mixtures thereof are particularly to be mentioned in this regard.

Usable organic builder substances are, for example, the polycarboxylic acids usable in the form of the free acid and/or sodium salts thereof, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, besides their builder effect, the property of an acidifying component, and thus also serve to establish a lower and milder pH for washing or cleaning agents. To be recited in this context are, in particular, citric acid, succinic acid, glutaric acid, adipic acid, gluconic acid, and any mixtures thereof.

Citric acid or salts of citric acid are used with particular preference as a builder substance.

A further particularly preferred builder substance is methylglycinediacetic acid (MGDA). According to the invention it is particularly preferred to add MGDA as at least one builder/complexing agent into the composition.

Oxydisuccinates and other derivatives of disuccinates, preferably ethylenediamine disuccinate, are additional suitable co-builders. Ethylenediamine-N,N′-disuccinate (EDDS might be used, preferably in the form of its sodium or magnesium salts. Also preferred in this context are glycerol disuccinates and glycerol trisuccinates.

In order to improve cleaning performance and/or to adjust viscosity, liquid cleaning agents may contain at least one hydrophobically modified polymer, preferably a hydrophobically modified polymer containing carboxylic acid groups, the weight amount of the hydrophobically modified polymer in terms of the total weight of the cleaning agent being preferably 0.1 to 10 wt.-%, preferably between 0.2 and 8.0 wt.-%, and in particular 0.4 to 6.0 wt.-%.

Polymers

Supplementing the builders described above, polymers having cleaning activity can be contained in the cleaning agent. The weight proportion of the polymers having cleaning activity in terms of the total weight of automatic cleaning agents according to the present invention is preferably from 0.1 to 20 wt.-%, preferably 1.0 to 15 wt.-%, and in particular 2.0 to 12 wt.-%.

Suitable polymers are known to those skilled in the art and comprise e.g. polymeric polycarboxylates; these are, for example, the alkali metal salts of polyacrylic acid or of polymethacrylic acid, for example those having a relative molecular weight from 500 to 70.000 g/mol or derivatives thereof.

The molecular weight indicated for polymeric polycarboxylates are herein weight-average molecular weights Mw of the respective acid form that were determined in principle by means of gel permeation chromatography (GPC), a UV detector having been used. The measurement was performed against an external polyacrylic acid standard that yields realistic molecular weight values because of its structural affinity with the polymers being investigated.

Suitable polymers are, in particular, polyacrylates that preferably have a molecular weight from 2.000 to 20.000 g/mol. Of this group in turn, the short-chain polyacrylates, which have molecular weights from 2.000 to 10.000 g/mol and particularly preferably from 3.000 to 5.000 g/mol, may be preferred because of their superior solubility.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt.-% acrylic acid and 50 to 10 wt.-% maleic acid have been found particularly suitable. Their relative molecular weight, based on free acids, is equal to in general 2.000 to 70.000 g/mol, preferably 20.000 to 50.000 g/mol, and in particular 30.000 to 40.000 g/mol.

Sulfonic acid group-containing polymers, in particular those from the group of the copolymeric polysulfonates, are used preferably as polymers having cleaning activity. These copolymeric polysulfonates contain, besides sulfonic acid group-containing monomer(s), at least one monomer from the group of the unsaturated carboxylic acids.

Unsaturated carboxylic acids of the formula R¹(R²)C═C(R³)COOH are used with particular preference as (an) unsaturated carboxylic acids(s), in which formula R¹ to R³, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴ where R⁴ is a saturated or unsaturated, straight-chain or branched hydrocarbon residue having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid, or mixtures thereof. The unsaturated dicarboxylic acids are of course also usable.

In the context of the sulfonic acid group-containing monomers, those of the formula R⁵(R⁶)C═C(R⁷)—X—SO₃H, in which R⁵ to R⁷, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or denote —COOH or —COOR⁴, where R⁴ is a saturated or unsaturated, straight-chain or branched hydrocarbon residue having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H,

in which R⁶ and R⁷, mutually independently, are selected from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

The sulfonic acid groups can be present in the polymers entirely or partly in neutralized form. The use of partly or entirely neutralized sulfonic acid group-containing copolymers is preferred.

The molecular weight of the sulfo-copolymers can be varied in order to adapt the properties of the polymers to the desired application. Preferred automatic dishwashing agents are characterized in that the copolymers have molecular weights from 2.000 to 200.000 gmol⁻¹, preferably from 4.000 to 25.000 gmol⁻¹, and in particular from 5.000 to 15.000 gmol⁻¹.

The copolymers can also encompass, besides carboxyl group-containing monomers and sulfonic acid group-containing monomers, at least one nonionic, preferably hydrophobic monomer. The use of these hydrophobically modified polymers allows to improve, in particular, the rinsing performance of automatic dishwashing agents according to the present invention.

Cleaning agents containing a copolymer encompassing

i) carboxylic acid group-containing monomer(s),

ii) sulfonic acid group-containing monomer(s),

iii) optionally (a) nonionic monomer(s), are preferred according to the present invention.

The use of these terpolymers has made it possible to improve the rinsing performance of automatic dishwashing agents according to the present invention with respect to comparable dishwashing agents that contain sulfopolymers without the addition of nonionic monomers.

The nonionic monomers used are preferably monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms.

Particularly preferred nonionic monomers are butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, α-olefins having 10 or more carbon atoms such as, for example, 1-decene, 1-dodecene, 1-hexadecene, 1-octadecene, and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

The weight proportion of the sulfonic acid group-containing copolymers in terms of the total weight of cleaning agents according to the present invention is preferably from 0.1 to 15 wt.-%, preferably from 1.0 to 12 wt.-%, and in particular from 2.0 to 10 wt.-%.

Organic co-builders that may be recited are in particular polycarboxylates/polycarboxylic acids, polymeric polycarboxylates, aspartic acid, polyacetals, dextrins or further organic co-builders.

Enzymes

The composition of the present invention may further comprise at least one enzyme.

In general, enzymes are often used to aid the removal of stains. In most cases enzymes react with the soiling and break it down into pieces that have increased water solubility or are better dispersible in the washing liquid.

The enzymes that can be used in cleaning compositions include, but are not limited to, proteases, amylases, lipases, cellulases, mannanase, peroxidase, oxidase, xylanase, pullulanase, glucanase, pectinase, cutinase, hemicellulases, glucoamylases, phospholipases, esterases, keratanases, reductases, phenoloxidases, lipoxygenases, ligninases, tannases, pentosanases, malanases, arabinosidases, hyaluronidase, chondroitinase, laccase or mixtures thereof. These enzymes are known to the skilled artisans.

Particularly preferred enzymes are selected from a group consisting of amylases, lipases, proteases, cellulases or mixtures thereof, most preferred at least one enzyme is a protease.

The enzyme(s) as well can be added to the composition in form of granules comprising the metal containing bleach catalyst and the enzyme as described in the co-pending European patent application having the application number 14 176 133.8. In such granules at least 2 wt.-% of the core of the granules is represented by the bleach catalyst and the enzyme(s). In a preferred embodiment of the invention the bleach catalyst and the enzyme(s) are provided in form of such granules, wherein at least 5 wt.-% of the core is represented by the bleach catalyst and the enzyme(s), preferably at least 10 wt.-%, more preferred at least 20 wt.-%, even more preferred at least 40 wt.-%. If no support is used in the inner core, the core of the granules may consist of the bleach catalyst and the enzyme(s) or up to 90 wt.-%, up to 80 wt.-% or up to 70 wt.-% are represented by the bleach catalyst and the enzyme(s).

In preferred embodiments of such granules at least one of the following parameters is fulfilled: the ratio of the at least one bleach catalyst to the at least one enzyme within the core is in the range from 100:1 to 1:100, preferably in the range from 50:1 to 1:50, more preferably in the range from 40:1 to 1:40, even more preferably in the range from 30:1 to 1:30, even more preferably in the range from 20:1 to 1:20, even more preferably in the range from 10:1 to 1:10, and most preferably in the range from 5:1 to 1:5; the ratio of the core to the coating (in wt.-%) is from 100:1 to 1:4, preferably from 80:1 to 1:2, more preferred from 60:1 to 1:1, even more preferred from 50:1 to 2:1 or 40:1 to 5:1, and most preferred in the range of 30:1 to 10:1 or 20:1.

Moreover, in a preferred embodiment the core may comprise as a further ingredient at least one of a water soluble organic polymers or carboxylate compounds, water soluble inorganic and organic salts, silicates, organic compounds having a molecular weight of less than 500 g/mol e.g. sugars, citrate, succinate, maleate and organic polymers having a molecular weight of 800-1,000,000 g/mol preferably selected from the group consisting of homo- and co-polymers, including graft co-polymers, more preferred from polyacrylic acid or derivatives thereof, polyethylene glycols or derivatives thereof, polyvinyl alcohol or derivatives thereof, polyvinylpyrrolidone or derivatives thereof, starch or derivatives thereof, cellulose or derivatives thereof, a polyvinyl alcohol-polyethylene glycol graft co-polymer, polyethylene, polysaccharides, polyglucose, guargum, pectin, lignin, cerragen gum, proteins others than enzymes, citrate, succinate, maleate, sugars, salts, and silicates or mixtures of any of the mentioned. and/or, carboxymethylcellulose, sugars having a molecular weight of less than 500 g/mol or at least one suitable carrier in the core.

In a particular preferred embodiment the granulate comprises carboxymethylcellulose in an amount of 0.5 to 10 wt. % in the granule. This amount in the granule allows the provision of the above mentioned amount of CMC in the cleaning composition.

Preferably, the granular particle comprising the bleach catalyst and the enzyme(s) is provided in combination with the remainder of the cleaning composition, preferably in form of a compressed cleaning composition. If the bleach catalyst and the enzyme(s) are provided in form of such granules in the cleaning composition, the ratio (wt/wt) of the granular particles to the remaining cleaning composition preferably is in the range of from 1:5 to 1:50.000, more preferably of from 1:10 to 1:10.000, and most preferably of from 1:25 to 1:500, which means that the composition comprises 0.002-20 wt.-%, preferably 0.01-10 wt.-%, more preferably 0.2-4 wt.-% of the granular particles.

Complexing Agent

A further preferred ingredient of cleaning compositions is at least one complexing agent. The cleaning composition of the present invention may optionally comprise one or more complexing agent(s) as at least one further ingredient.

Complexing agents are commonly used as co-builders to support the performance of the builders.

A function of complexing agents is to capture trace metal ions like, Cu(II), Fe(II), Fe(III), Mn(II), Cd(II), Co(II), Cr(III), Hg(II), Ni(II), Pb(II), Pd(II), Zn(II), Ca(II), Mg(II) These ions can interfere with or disturb certain processes of the cleaning in the washing machine, like e.g. the bleach performance.

The complexing agent(s) that are known to be used in cleaning compositions include, but are not limited to S,S-ethylenediamine-N,N′-disuccinic acid (S,S-EDDS), ethylenediaminetetraacetic acid (EDTA), diethylene triamine penta(methylene phosphonate) (DETPMP), nitrilotriacetic acid (NTA), ethanol diglycine (EDG), imino disuccinic acid (IDS), methylglycine diacetic acid (MGDA), diethylene triamine pentaacetic acid (DTPA), ethylene diamine dihydroxyphenyl acetic acid (EDDHA), N-(hydroxyethyl) ethylenediamine triacetic acid (HEDTA), hydroxyethylidene-1,1-diphosphonic acid (HEDP), phytic acid, diethylene triamine (DETA), triethylene tetramine (TETA), tetraethylene pentamine (TEPA), aminoethyl ethanolamine (AEEA), glutamic acid N,N-diacetic acid (GLDA), 1,3-propylenediamine tetraacetic acid (PDTA), glucoheptonic acid, dipicolinic acid, ethylene diamine tetra (methylene phosphonic acid) (EDTMPA), 2-hydroxyethyliminodiacetic acid (HEIDA) or water soluble salts thereof or mixtures thereof.

Further, phosphonates are preferred complexing agents. Useful phosphonates encompass, besides 1-hydroxyethane-1,1-diphosphonic acid, a number of different compounds such as, for example, diethylenetriaminepenta(methylenephosphonic acid) (DTPMP). Hydroxyalkane- or aminoalkanephosphonates are preferred in this Application. Among the hydroxyalkanephosphonates, 1-hydroxyethane-1,1-diphosphonate (HEDP) is of particular importance as a co-builder. It is used preferably as a sodium salt, the disodium salt reacting neutrally and the tetrasodium salt in alkaline fashion (pH 9). Suitable aminoalkanephosphonates are, e.g. ethylenediaminetetramethylenephosphonate (EDTMP), diethylenetriaminepentamethylenephosphonate (DTPMP), as well as higher homologs thereof. They are used preferably in the form of the neutrally reacting sodium salts, e.g. as a hexasodium salt of EDTMP resp. as a hepta- and octasodium salt of DTPMP. Of the class of the phosphonates, HEDP is preferably used as a builder. The aminoalkanephosphonates moreover possess a pronounced ability to bind heavy metals. It may accordingly be preferred, in particular if the agents also contain bleaches, to use aminoalkanephosphonates, in particular DTPMP, or mixtures of the aforesaid phosphonates.

Particularly preferred are one or more phosphonate(s) from the group of
a) aminotrimethylenephosphonic acid (ATMP) and/or salts thereof,
b) ethylenediaminetetra(methylenephosphonic acid) (EDTMP) and/or salts thereof,
c) diethylenetriaminepenta(methylenephosphonic acid) (DTPMP) and/or salts thereof,
d) 1-hydroxyethane-1,1-diphosphonic acid (HEDP) and/or salts thereof,
e) 2-phosphonobutane-1,2,4-tricarboxylic acid (PBTC) and/or salts thereof,
f) hexamethylenediaminetetra(methylenephosphonic acid) (HDTMP) and/or salts thereof,
g) nitrilotri(methylenephosphonic acid) (NTMP) and/or salts thereof.

Washing- or cleaning compositions that contain 1-hydroxyethane-1,1-diphosphonic acid (HEDP) or diethylenetriaminepenta(methylenephosphonic acid) (DTPMP) as phosphonates are particularly preferred.

The cleaning compositions according to the present invention can of course contain two or more different phosphonates.

Preferred cleaning compositions may contain at least one complexing agent from the group above in terms of the total weight of the cleaning agent in a range from 0.01 to 8.0 wt.-%, preferably 0.02 to 5.0 wt.-%, and in particular 0.05 to 3.0 wt.-%.

Builders and co-builders can generally be added to the composition in acid form, neutralized or in a partly neutralized form. When used in a partly or completely neutralized form alkali metal salts are preferred, like sodium, potassium and lithium or ammonium salts.

Surfactants

The cleaning composition of the present invention preferably comprise one or more surfactants as at least one further ingredient. Said surfactants may be selected from anionic, non-ionic, cationic or amphoteric surfactants, however, are preferably anionic and/or non-ionic.

The main functions of surfactants are changing the surface tension, dispersing, foam controlling and surface modification.

A special type of surfactants used in automatic dishwasher cleaning compositions is a ‘carry-over’ surfactant. A ‘carry-over’ surfactant has the property that some amount of the surfactant used remains in the machine after the rinsing cycles to give a performance during the final rinsing cycle and the (optional) drying phase of the whole washing cycle of the dishwashing machine. This type of surfactant is described in EP 1 524 313 in more detail.

For automatic dishwasher cleaning compositions alkoxylated nonionic surfactants and Gemini surfactants are commonly used. The alkoxy groups mostly consist of ethyleneoxide, propyleneoxide and butyleneoxide or combinations thereof. Also amphoteric surfactants are known to be used in automatic dishwasher cleaning compositions.

Alkyl poly glucoside surfactants can also be used in automatic dishwasher cleaning compositions, preferably in a low foaming form.

Examples of possible surfactant as at least one further ingredient can be selected from the group consisting of anionic, cationic, non-ionic as well as amphoteric surfactants, and preferably may be selected from the group consisting of anionic or non-ionic surfactants or mixtures thereof. More preferably, the composition of the present invention comprises a mixture of anionic and non-ionic surfactants. If surfactants are present in the composition of the present invention, their amount preferably may be in the range of from 0.1 to 50 wt.-%, more preferably of from 1 to 30 wt.-%, even more preferably of from 1,5 to 25 wt.-%, even more preferably of from 1,5 to 20 wt.-%, and most preferably of from 1,5 to 15 wt.-%, based on the whole composition. Preferably the composition comprises at least one nonionic surfactants and optionally at least one anionic surfactant, wherein the ratio of the combined amount of anionic surfactants to the amount of non-ionic surfactants preferably is greater than 1:1 and more preferably is in the range of from 1,1:1 to 5:1.

Anionic surfactants suitable to be used in cleaning compositions, in particular in combination with enzymes are well known in the state of the art and include for example alkylbenzenesulfonic acids or salts thereof and alkylsulfonic acids or salts thereof.

Suitable anionic alkylbenzene sulfonic or alkylsulfonic surfactants include in particular C₅-C₂₀, preferably C₁₀-C₁₆, even more preferably C₁₁-C₁₃ alkylbenzenesulfonates, in particular linear alkylbenzene sulfonates (LAS), alkylestersulfonates, primary or secondary alkenesulfonates, sulfonated polycarboxylic acids and any mixtures thereof. Alkylethersulfates may be used as well.

Further preferred surfactants are non-ionic, in particular low foaming non-ionic surfactants. Washing or cleaning agents, particularly cleaning agents for dishwashing and among this preferably for automatic dishwashers, are especially preferred when they comprise non-ionic surfactants from the group of the alkoxylated alcohols. Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched residues in the form of the mixtures typically present in Oxo alcohol residues. Particularly preferred are, however, alcohol ethoxylates with linear groups from alcohols of natural origin with 6 to 22 carbon atoms, e.g. from coco-, palm-, tallow- or oleyl alcohol, and an average of 2 to 8 EO per mole alcohol. Exemplary preferred ethoxylated alcohols include C₁₂₋₁₄ alcohols with 3 EO or 4 EO, C₉₁₁ alcohols with 7 EO, C₁₃₋₁₅ alcohols with 3 EO, 5 EO or 7 EO, C₁₂₋₁₈ alcohols with 3 EO, 5 EO or 7 EO and mixtures thereof, such as mixtures of C₁₂₋₁₄ alcohols with 3 EO and C₁₂₋₁₈ alcohols with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 100 EO.

Accordingly, ethoxylated non-ionic surfactant(s) prepared from C₆₋₂₀ monohydroxy alkanols or C₆₋₂₀ alkylphenols or C₁₂₋₂₀ fatty alcohols and more than 12 mole, preferably more than 12 mole and especially more than 20 mole ethylene oxide per mole alcohol, are used with particular preference. A particularly preferred non-ionic surfactant is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these non-ionic surfactants, the so-called narrow range ethoxylates are particularly preferred.

Moreover, surfactant(s) that comprise one or more tallow fat alcohols with 20 to 30 EO in combination with a silicone defoamer are particularly preferably used.

Examples of preferred surfactants are selected from a group consisting of gemini surfactants with a short C-Chain (C8-C12) as spacer and two times 5-40EO groups as hydrophilic headgroups (e.g. Dehypon GRA, Dehypon E 127, Genapol EC 50, Genapol EC 65) and Long Chain (C12-22) high ethoxylateted (20-100EO) carry over surfactant Lutensol AT Types.

Further all surfactants commonly known to be used in cleaning compositions can be part of the composition, this includes all anionic, non-ionic, cationic and amphoteric surfactants known in the art. The present invention is not limited by any of the surfactants commonly used in automatic dishwashing compositions.

Bleaching Agent(s)

The composition of the present invention preferably comprises one or more bleaching agent(s) as at least one further ingredient.

Bleaching agents can be used in a cleaning composition either alone or in combination with a bleach activator and/or a bleach catalyst. The function of the bleaching agent is the removal of bleachable stains and to achieve an antibacterial effect on the load and inside of the (dish)washing machine.

Bleaching agents that can be used in cleaning compositions include, but are not limited to, active chlorine compounds, inorganic peroxygen compounds and organic peracids. Examples are sodium percarbonate, sodium perborate monohydrate, sodium perborate tetrahydrate, hydrogen peroxide, hydrogen peroxide based compounds, persulfates, peroxymonosulphate, peroxodisulphate, ε-phthalimido-perox-caproic acid, benzoyl peroxide, sodium hypochlorite, sodium dichloroisocyanurate, etc. as well as mixtures thereof. At least one bleaching agent is selected from inorganic bleaching agents, preferably from sodium perborate or sodium percarbonate or a mixture thereof.

The weight proportion of the bleaching agent in terms of the total weight of the cleaning composition is preferably from 1 to 40 wt.-%, more preferably from 2 to 30 wt.-%, and most preferred from 3 to 20 wt.-%.

As mentioned above, the cleaning composition of the present invention doesn't comprise TAED. In a preferred embodiment the present composition doesn't comprise any bleaching activator.

The following further ingredients can be added in commonly used amounts:

Anti-Redeposition Agent(s)

The cleaning composition of the present invention may optionally comprise one or more anti-redeposition agent(s) as at least one further ingredient.

The main function of anti-redeposition agents is the aid to prevent the soil from redepositioning on the washing substrate when a washing liquor provides insufficient soil anti-redeposition capacity.

Anti-redeposition agent(s) can provide their effect by becoming adsorbed irreversibly or reversibly to the soil particles or to the substrate. Thereby the soil becomes better dispersed in the washing liquor or the substrate is occupied with anti-redeposition agent(s) on those places the soil could redeposit.

The anti-redeposition agent(s) that are known to be used in cleaning compositions besides CMC include, but are not limited to, polyester-PEG co-polymer, polyvinyl pyrrolidone based polymers etc.

Anti-Corrosion Agent(s)

The cleaning composition of the present invention may optionally comprise one or more anti-corrosion agent(s) as one further ingredient.

The main function of anti-corrosion agents is to minimize the amount of material damage caused on glass and metal during automatic dishwashing.

Glass corrosion occurs because metal ions are dissolved out of the glass surface. This occurs more intensively when soft tap water is used for the cleaning. In this case the builders and complexing agents can only bind a limited amount of hardness ions from the tap water and extract then (alkaline earth) metals from that glass surface. Also of influence for glass corrosion are the washing temperature, the quality of the glassware and the duration of the cleaning program.

Glass corrosion becomes visible in white lines or white clouds on the glass surface. The glass corrosion damage can be repaired by replacing the extracted metal ion, however preferably the glassware can be protected against glass corrosion.

Metal corrosion occurs in many cases when oxide, sulphide and/or chlorides are present in the washing liquid, which normally is a mixture of tap water, soil and a cleaning composition. The anions react with the metal or metal alloy surface of articles that are contained in the dishwashing machine. In the case of silver the silver salts which are formed give a discoloration of the silver metal surface which becomes visible after one or more cleaning cycles in an automatic dishwashing machine.

The occurrence of metal corrosion can be slowed down or inhibited by use of detergent ingredients that provides the metal with a protective film or ingredients forming compounds with the oxide, sulfide and/or chlorides to prevent them from reacting with the metal surface.

The protective film can be formed because the inhibitor ingredient may become insoluble on the metal or metal alloy surface, or because of adsorption to the surface by aid of free electron pairs of donor atoms (like N, S, O, P). The metals can be silver, copper, stainless steel, iron, etc.

The types of anti corrosion agents which often are used in cleaning compositions or which are described in literature include, but are not limited to, triazole-based compounds (like tolyltriazole and 1,2,3-benzotriazole), polymers with an affinity to attach to glass surfaces, strong oxidizers (like permanganate), cystine (as silver-protector), silicates, organic or inorganic metal salts, or metal salts of biopolymers. The metal of these metal salts can be selected from the group aluminum, strontium, barium, titanium, zirconium, manganese, lanthanum, bismuth, zinc, wherein the latter two are most commonly applied for the prevention of glass corrosion. Further compounds to be added e.g. are manganese compounds as described e.g. in WO2005/095570.

Silver Protecting Agents

The cleaning composition of the present invention may optionally comprise one or more silver protecting agent(s) as one further ingredient.

Several silver protection agents that reduce silver corrosion have been described in the patent literature. The British patent GB 1131738 discloses dishwashing agents which use benzotriazoles as a corrosion inhibitor for silver. Benzotriazoles in the context of silver corrosion protection are also disclosed in the U.S. Pat. No. 2,549,539 and the European patents EP 135 226 and EP 135 227.

Another group of compounds used as silver corrosion protection agents comprises manganese salts or manganese complex compounds. The German patent number DE 4315397 discloses organic and anorganic redox compounds containing manganese(II) compounds, e.g. manganese(II)sulfate, manganese(II)acetoacetate and manganese(II)acetylacetonate. These low valent manganese compounds preferably have to be coated prior to their use in cleaning compositions containing bleaching agents in order to avoid their oxidation or decomposition during storage. EP 530 870 A1 discloses dinuclear manganese complexes in machine dishwashing compositions, wherein the manganese is in the III or IV oxidation state. EP 697 035 A1 describes automatic dishwashing compositions comprising at least partly water-soluble metal salts and/or metal complexes comprising manganese salts or complexes.

Examples of further corrosion inhibitors or anti-tarnish aids are paraffin oil, typically a predominantly branched aliphatic hydrocarbon having a number of carbon atoms in the range of from about 20 to about 50; preferred paraffin oil is selected from predominantly branched C 25-45 species with a ratio of cyclic to noncyclic hydrocarbons of about 32:68. A paraffin oil meeting those characteristics is sold by Wintershall, Salzbergen, Germany, under the trade name WINOG 70. When present, such protecting materials are preferably incorporated at low levels, e.g., from about 0.01 wt.-% to about 5 wt.-% of the automatic dishwashing composition.

Other corrosion inhibitor compounds include benzotriazole, tolyltriazole and comparable compounds; mercaptans or thiols including thionaphtol and thioanthranol; and finely divided Aluminium fatty acid salts, such as aluminium tristearate. The formulator will recognize that such materials will generally be used judiciously and in limited quantities so as to avoid any tendency to produce spots or films on glassware or to compromise the bleaching action of the compositions. For this reason, mercaptan anti-tarnishes which are quite strongly bleach-reactive and common fatty carboxylic acids which precipitate with calcium in particular are preferably avoided.

Dyes

The composition of the present invention may optionally comprise one or more dyes as at least one further ingredient. The dye is used to colour the cleaning composition, parts of the composition or speckles in the composition. This might render the product more attractive to the consumer.

Dyes that can be used in cleaning compositions include, but are not limited to, Nylosan yellow N-7GL, Sanolin brilliant flavine 8GZ, Sanolin yellow BG, Vitasyn quinoline yellow 70, Vitasyn tartrazine X90, Puricolor yellow AYE23, Basacid yellow 232, Vibracolor yellow AYE17, Simacid Eosine Y, Puricolor red ARE27, Puricolor red ARE14, Vibracolor red ARE18, Vibracolor red ARE52, Vibracolor red SRE3, Basacid red 316, Ponceau SX, Iragon blue DBL86, Sanolin blue EHRL, Sanolin turquoise blue FBL, Basacid blue 750, Iragon blue ABL80, Vitasyn blue AE90, Basacid blue755, Vitasyn patentblue V 8501, Vibracolor green AGR25. These dyes are available at the firms Clariant or BASF.

Perfumes

The composition of the present invention may optionally comprise one or more perfumes as at least one further ingredient. The perfume is added to the cleaning composition to improve the sensorial properties of the product or of the machine load after cleaning.

The perfume can be added to the cleaning composition as a liquid, paste or as a co-granulate with a carrier material for the perfume. To improve the stability of the perfume it can be used in an encapsulated form or as a complex like for example a perfume-cyclodextrine complex.

Also perfumes that have a deodorizing effect can be applied. Such perfumes or raw materials encapsulate malodours by binding to their sulphur groups.

Miscellaneous

The composition may further comprise other ingredients allowing a desired performance as known by the skilled artisan without limiting the invention.

In a particularly preferred embodiment of the invention a cleaning composition comprises granulate particles comprising a core and a coating, wherein the core comprises at least one metal containing bleach catalyst and at least one enzyme and the coating comprises at least one water soluble coating compound, wherein within the core the metal containing bleach catalyst is either in intimate mixture with the enzyme(s) or an inner core or layer comprising the metal containing bleach catalyst is coated with the enzyme(s), wherein at least 2 wt.-% of the ingredients of the core are represented by the metal containing bleach catalyst and the enzyme(s), said granulate particle comprises further CMC (optionally as part of the coating), wherein the cleaning composition comprises further 1-40 wt.-% of sodium percabonate or sodium perborate, 0.1-10 wt.-% low-foaming non-ionic surfactant, 0.1-80 wt.-% builder and optionally 0.1-20 wt.-% polymer (wt.-% based on the entire cleaning composition), but no bleach activator.

In a preferred embodiment of the invention the cleaning composition is a dishwashing composition, preferably an automatic dishwashing composition.

In a further aspect the invention provides a method for cleaning tableware, glassware, dishware, cookware, flatware and/or cutlery in an automatic dishwashing appliance, said method comprising treating soiled tableware in an automatic dishwasher with a cleaning composition according to this invention or a solution comprising said cleaning composition.

In a further aspect of the invention said granular particles are used in a cleaning composition, preferably said cleaning composition is used for dishwashing.

### EXAMPLES

To compare the remainder of solid material in waste water or the filter system of modern automatic dishwashing machines, commonly used cleaning compositions (not yet comprising metal bleach catalyst, CMC and TAED) are supplemented either with a bleach catalyst and CMC as shown below, or with a granulate particle according to the co-pending European patent application with the application number 14 176 133.8.

The basic cleaning formulation used in these tests represents standard modern cleaning compositions without any bleach catalyst, CMC and bleach activator, supplemented by the further ingredients as shown below in the tables. Thus, the ingredients bleach catalyst or enzyme-bleach catalyst granulate and CMC are supplemented by the addition of a standard cleaning composition resulting in 19 g in total.

The basic cleaning composition (in the below tables “basic ADD”) comprised the following ingredients: sodium tripolyphosphate, sodium carbonate, disilicate, sodium percarbonate, acrylic acid/sulphonated copolymer, acrylic based polymer, phosphonate, carboxy methyl innulin, modified fatty alcohol polyglycolether, amylase granulate, protease granulate, zinc salt, benzotriazole, dye, poly ethylene glycol and perfume.

Cleaning compositions were used in an automatic dishwasher (Miele G 1222 SC (GSL)) at a cleaning temperature of 65° C. using water with a hardness of 21° dH. Each dosage used as cleaning composition was 19 g per wash with a ballast soil of 25 g. The solid material in waste water was considered by visual inspection of the fine filter of the dishwashing machine after the below defined number of wash cycles.

Composition of Ballast Soil:

| | |
|---|---|
| Tomato Ketchup | 100.0 g |
| Mustard | 100.0 g |
| Gravy | 100.0 g |
| Potato starch | 20.0 g |
| Benzoic acid | 4.0 g |
| Milk | 200.0 g |
| Tab water | 818.0 g |
| Egg-yolk | 240.0 g |
| Margarine | 400.0 g |

### Example 1

Amounts in the tables are given in %, if not otherwise defined

100 repetitions (wash cycles) in GSL1222

| Composition | A | B | C |
|---|---|---|---|
| Basic ADD | 100 | 96.3 | 100 |
| MnTACN | 0 | 0 | 6.6 mg |
| TAED (100% act.) | 0 | 3.4 | 0 |
| CMC | 0 | 0.3 | 0 |
| TOTAL | 100 | 100 | 100 |
| Residues on filter | Yes | No | Yes |

30 repetitions (wash cycles) in GSL1222

| Composition | D | E | F | G | H | I |
|---|---|---|---|---|---|---|
| Basic ADD | 100 | 99.9 | 99.7 | 99.1 | 100 | 100 |
| MnTACN | 4 mg | 4 mg | 4 mg | 4 mg | 0 | 0 |
| CMC | 0 | 0.1 | 0.3 | 0.9 | 0 | 0.3 |
| TAED (100% act) | 0 | 0 | 0 | 0 | 3.2 | 3.2 |
| TOTAL | 100 | 100 | 100 | 100 | 103.2 | 103.5 |
| Residues on filter | Yes | No | No | No | Yes | No |

1. A cleaning composition comprising a metal-containing bleach catalyst and carboxymethylcellulose (CMC).

2. The cleaning composition according to claim 1, wherein the composition doesn't comprise a bleach activator.

3. The cleaning composition according to claim 1, further comprising at least one type of a builder, at least one type of a surfactant, at least one polymers/cobuilders and at least one enzyme.

4. The cleaning composition according to claim 1, wherein the at least one metal-containing bleach catalyst is a cobalt (Co) containing bleach catalyst or a manganese (Mn) containing bleach catalyst.

5. The cleaning composition according to claim 1, wherein the beach catalyst is present in an amount of at least 0.002 wt.-%, preferably at least 0.004 wt.-%, more preferably from 0.008 to 0.23 wt.-%, more preferably from 0.012 to 0.15 wt.-%, even more preferably from 0.016 to 0.12 wt.-%, most preferably from 0.016 to 0.08 wt.-% relative to total amount of the cleaning composition.

6. The cleaning composition according to claim 1, wherein the carboxymethylcellulose is present in an amount of at least 0.02% (w/w), preferably at least 0.05% (w/w) relative to total amount of the cleaning composition, preferably in a range of 0.05 to 5% (w/w), more preferred in a range of 0.1 to 4%, even more preferred in a range of 0.15 to 3% (w/w) relative to total amount of the cleaning composition.

7. The cleaning composition according to claim 1, wherein the carboxymethylcellulose has an average degree of substitution (ds) of at least 0.1, preferably between 0.1 to 2.5, preferably between 0.2 and 2.0, more preferably between 0.3 and 1.5 and most preferably between 0.4 and 1.0.

8. The cleaning composition according to claim 1, comprising the bleach catalyst and the carboxymethylcellulose in a form of a co-granulate.

9. The cleaning composition according to claim 3, comprising the bleach catalyst and the at least one enzyme(s) in a form of a co-granulate.

10. The cleaning composition according to claim 3, wherein the at least one enzyme is selected from the group consisting of amylases, lipases, glucooxidases, pectinases, proteases, cellulases, mannanase, peroxidase, oxidase, xylanase, pullulanase, glucanase, cutinase, hemicellulases, glucoamylases, phospholipases, esterases, keratanases, reductases, phenoloxidases, lipoxygenases, ligninases, tannases, pentosanases, malanases, arabinosidases, hyaluronidase, chondroitinase laccase and a mixture thereof.

11. The cleaning composition according to claim 1, wherein the cleaning composition is a dishwashing composition.

12. The cleaning composition according to claim 1, wherein the cleaning composition comprises the bleach catalyst and the carboxymethylcellulose, 0.1-90 wt.-% builder, 0.1-10 wt.-% nonionic surfactant, preferably a low-foaming non-ionic surfactant, 1-40 wt.-% of sodium percarbonate or sodium perborate, and 0.1-20 wt.-% polymer relative to total amount of the cleaning composition.

13. A method for cleaning tableware in an automatic dishwashing appliance, said method comprising treating soiled tableware in an automatic dishwasher with the cleaning composition according to claim 1 or a solution comprising said cleaning composition according to claim 1.

14. A method for cleaning tableware, comprising:
adding the cleaning composition according to claim 1 into an automatic dishwashing appliance, and
contacting the cleaning composition to soiled tableware in the automatic dishwashing appliance.

15. The cleaning composition according to claim 3, further comprising non-ionic and/or anionic surfactants.

16. The cleaning composition according to claim 1, wherein the metal-containing bleach catalyst is Mn^{IV}₂(μ-O)₃(1,4,7-trimethyl-1,4,7-triazacyclononane)₂-(PF₆)₂ (MnTACN).

17. The cleaning composition according to claim 3, wherein the at least one enzyme is selected from the group consisting of proteases, lipases, cellulases, amylases and a mixture thereof.

18. The cleaning composition according to claim 3, wherein the at least one enzyme is a protease.

19. The cleaning composition according to claim 1, wherein the cleaning composition is an automatic dishwashing composition.
